(19) United States
(12) Patent Application Publication
(10) Pub. No.: US 2004/0028048 A1
(43) Pub. Date: Feb. 12, 2004

(54) Host management method and packet transmission method in network switch

(75) Inventor: Yong Suk Jin, Incheon-si (KR)

Correspondence Address: FLESHNER & KIM, LLP, P.O. BOX 221200, CHANTILLY, VA, 20153, US

(73) Assignee: LG Electronic, Inc.

(21) Appl. No.: 10/621,370

(22) Filed: Jul. 18, 2003

(30) Foreign Application Priority Data
Jul. 22, 2002 (KR) 42961/2002

(51) Int. Cl. H04L 12/28

(52) U.S. Cl. 370/392; 370/395.31

(57) ABSTRACT

There is provided a packet transmission method in which packet transmission efficiency is improved using a network switch. The network switch includes a management table different from a MAC table. In the network switch, a MAC address of a host is registered in the management table when a failure occurs in the host. In one embodiment, packets are discarded instead of broadcast to the network when the MAC address of the host is not found. Thus, the network switch according to one embodiment of the present invention can improve packet transmission efficiency by preventing traffic from occurring in the network.

### BACKGROUND OF THE INVENTION

1. Field of the Invention

The present invention relates to a network switch, and more particularly, to a host management method and packet transmission method in a network switch in which a MAC address of a host is separately managed to thereby improve packet transmission efficiency.

2. Background of the Related Art

Generally, network switches are devices for selecting paths or lines so as to transmit unit data to a destination. Such a network switch can include a router function of determining to which one of adjacent network destinations data is transmitted.

The network Switch includes a Layer 2 (i.e., an L2 switch related to a data link layer) and a Layer 3 (i.e., an L3 switch or an IP switch performing a routing function of a network layer) in OSI reference model. FIG. 1 is a schematic view of a network system with conventional L2 switches. Referring to FIG. 1, the network system includes a plurality of L2 switches 110 and 130. A plurality of terminals 111, 113 and 131, used as user terminals, and various servers (i.e., Web server, FTP server or TELNET server) are connected to the L2 switches 110 and 130. In FIG. 1, although only the TELNET server 133 as a typical example is connected to the L2 switches 110 and 130, various servers can be generally connected to the L2 switches 110 and 130.

The plurality of terminals 111, 113 and 131 arc connected to the TELNET server 133 through the L2 switches 110 and 130, and thus perform desired operations and obtain desired information. The L2 switches 110 and 130 include a MAC table and have a server management function of registering and maintaining MAC addresses of various servers, i.e., hosts.

FIG. 2 is a flowchart showing a host management method in the conventional L2 switch. Referring to FIG. 2, if a host requests a registration to an L2 switch (S211), the L2 switch ascertains whether or not a MAC address of the host is registered in a MAC table (S214). If the MAC address of the host is not registered in the MAC table, the MAC address of the host is registered into the MAC table (S217).

To maintain and update the MAC table, the L2 switch checks whether or not the corresponding host crashes. If the corresponding host crashes while it is registered in the L2 switch (S220), the MAC table is updated. Here, the step S220 can also check inaccessibility to the host due to other failures as well as the crash of the corresponding host. In other words, when the L2 switch periodically communicates with the corresponding host, if there is no response from the corresponding host, the L2 switch judges that there occurs the crash or other failure occurred in the corresponding host. In that case, the L2 switch deletes the previously registered MAC address of the corresponding host from the MAC table (S223).

If the crashed host is restored (S226), the process proceeds to the step S211 of requesting the registration. Then, the MAC address of the corresponding host is registered in the MAC table.

FIG. 3 is a flowchart showing a packet transmission method for when a packet is received while the L2 switch is managing the corresponding host as shown in FIG. 2. In FIG. 3, there is shown a packet transmission method in the conventional L2 switch. Referring to FIG. 3, if the L2 switch receives a packet (S251), the L2 switch ascertains a destination MAC address contained in the packet (S254).

The L2 switch retrieves the MAC table to ascertain whether or not there is the ascertained destination MAC address is in the MAC table (S257). If the destination MAC address is in the MAC table, the packet is transmitted to a host corresponding to the destination MAC address (S260). At this time, if the host corresponding to the destination MAC address crashes, the MAC address of the host is deleted from the MAC table.

Accordingly, if the destination MAC address of the packet is not in the MAC table, the L2 switch broadcasts the packet to the network. Here, “broadcast” means that the packet is transmitted randomly without specific destinations.

For example, as shown in FIG. 4, when a MAC address of the TELNET server 133 is deleted from the MAC table of the L2 switch 130 because the TELNET server 133 crashes, a packet to be transmitted to the terminal 113 may be inputted into the L2 switch 110 through another L2 switch. In that case, the L2 switch 110 cannot find the MAC address of the TELNET server 133 in the MAC table and thus the inputted packet is transmitted through the network to the terminal 111, the terminal 131, other terminals or various servers.

In the conventional L2 switch that manages specific hosts, if a specific host crashes, the MAC address of the specific host is deleted from the MAC table of the L2 switch. Therefore, the packets inputted into the L2 switch are not transmitted to the specific host. Instead, the packets are broadcast so that they are transmitted to all terminals or various servers. Accordingly, since the packets received from a plurality of terminals and to be transmitted to the specific host are broadcast as described above, unnecessary traffic occurs in the network so that overall performance and efficiency of the network are degraded.

### SUMMARY OF THE INVENTION

An embodiment of the present invention provides a packet transmission method in a network switch in which traffic is prevented from occurring in a network and thus packet transmission efficiency is improved by providing an additional management table in addition to a MAC table. Another embodiment of the present invention provides a host management method in a network switch in which traffic is prevented from occurring in a network by registering a MAC address of a host into a management table if that host crashes.

One embodiment of the present invention provides a packet transmission method in a network switch. The method comprises the steps of: if a packet is received, ascertaining whether or not a destination MAC address of a packet is in a MAC table; if the destination MAC address of the host is not in the MAC table, ascertaining whether or not the destination MAC address of the packet is in a management table; and if the destination MAC address of the packet is in the management table, discarding the packet.

The packet transmission method in the network switch further comprises the step of transmitting the packet to a host corresponding to the destination MAC address of the packet if the destination MAC address of the packet is in the MAC table. The packet transmission in the network switch further comprises the step of broadcasting the packet to the network if the destination MAC address of the packet is not in the management table.

In accordance with a preferred embodiment of the present invention, there is provided a host management method in a network switch, which comprises the steps of if a registration request of a host is received, registering a MAC address of the host into a MAC table; and if there occurs inaccessibility to the host, moving the MAC address registered in the MAC table to a management table. For example, the inaccessibility of the host can represent an occurrence of a host failure. The host management in the network switch further comprises the step of moving the MAC address registered in the management table to the MAC table, if the inaccessibility to the host is resolved.

In accordance with another preferred embodiment of the present invention, the MAC address of the host, which is registered in a MAC table, is moved to a management table if inaccessibility to the host occurs. In accordance with further another preferred embodiment of the present invention, the packet inputted into the network switch and to be transmitted to the host is discarded if the MAC address of the host is registered into a management table due to inaccessibility of the host.

It is to be understood that both the foregoing general description and the following detailed description of the present invention are exemplary and explanatory and are intended to provide further explanation of the present invention as claimed. Additional advantages, and features of the invention will be set forth in part in the description which follows and in part will become apparent to those having ordinary skill in the art upon examination of the following or may be learned from practice of the invention. The advantages of the invention may be realized and attained as particularly pointed out in the appended claims.

### BRIEF DESCRIPTION OF THE DRAWINGS

The accompanying drawings, which are included to provide a further understanding of the present invention and are incorporated in and constitute a part of this application, illustrate embodiment(s) of the present invention and together with the description serve to explain the principle of the present invention. In the drawings:

FIG. 1 is a schematic view of a network system with conventional L2 switches;

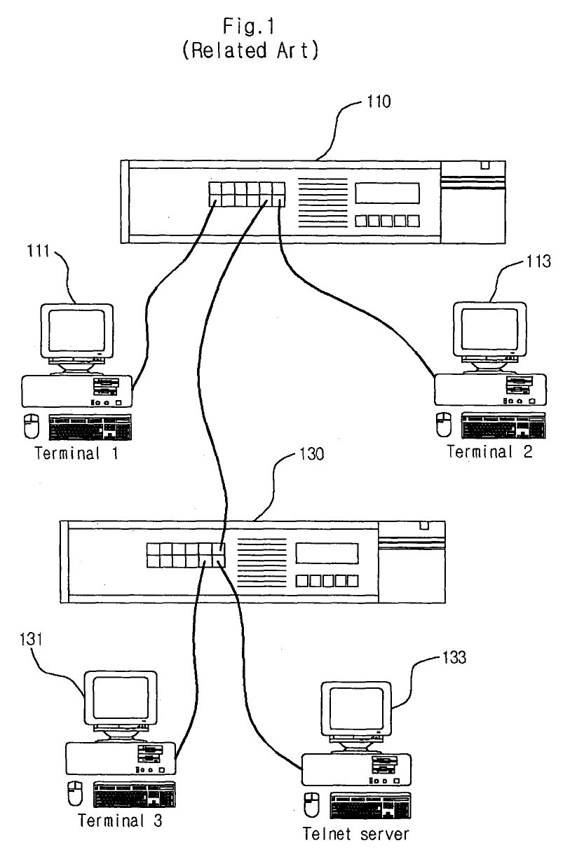

FIG. 2 is flowchart showing a host management method in the conventional L2 switches;

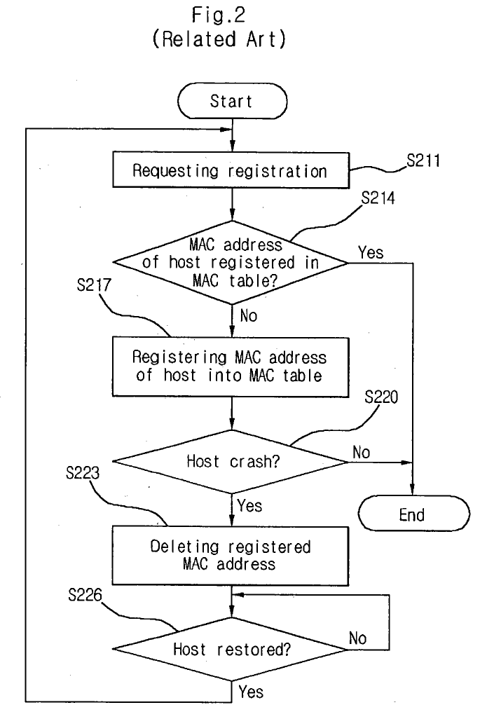

FIG. 3 is a flowchart showing a packet transmission method in the conventional L2 switches;

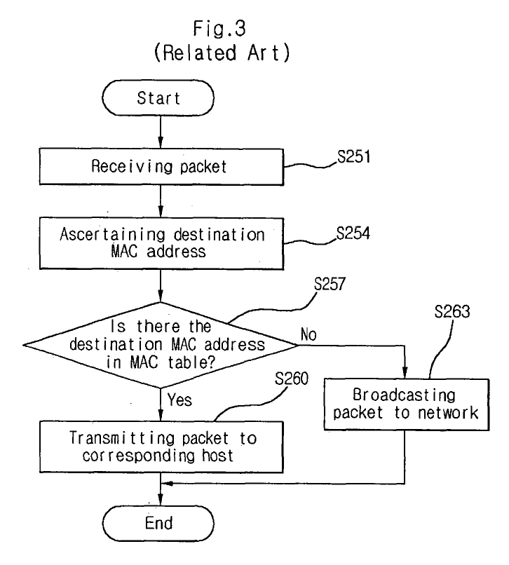

FIG. 4 is a schematic view showing a packet transmission when a failure occurs in the network system with the conventional L2 switches;

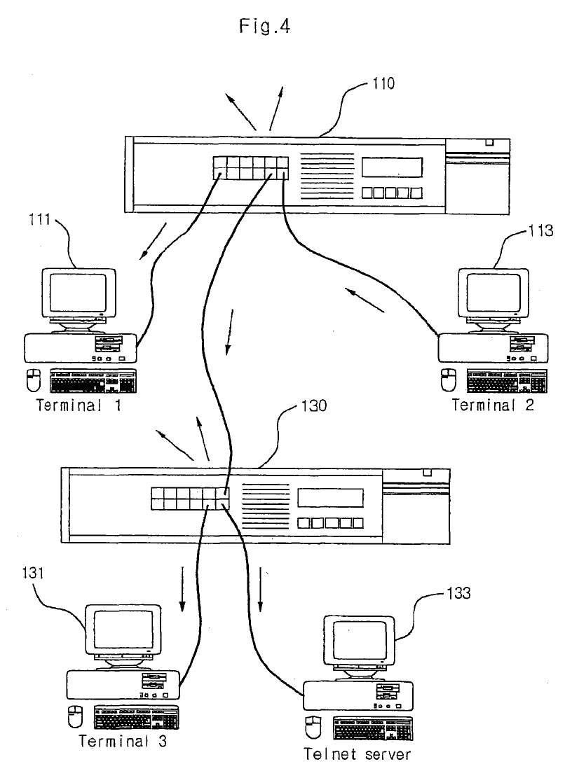

FIG. 5 is a flowchart illustrating a host management method in L2 switches in accordance with an embodiment of the present invention;

FIG. 6 is a flowchart illustrating a packet transmission method in the L2 switches in accordance with an embodiment of the present invention; and

FIG. 7 is a view showing a packet transmission when a failure occurs in the network system with the L2 switches in accordance with an embodiment of the present invention.

### DETAILED DESCRIPTION OF PREFERRED EMBODIMENTS

Reference will now be made in detail to a preferred embodiment of the present invention with reference to the attached drawings. For the sake of convenience in explanation, the same reference symbols as the conventional network system are used in the same elements contained in a network system of the present invention although these elements may contain improvements.

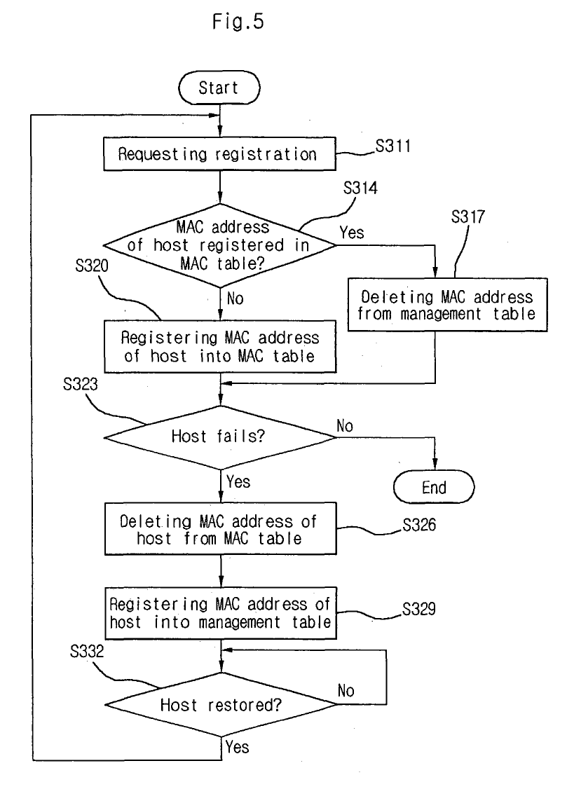

FIG. 5 is a flowchart illustrating a host management method in an L2 switch in accordance with a preferred embodiment of the present invention. Referring to FIG. 5, if a host requests a registration to an L2 switch (S311), the L2 switch ascertains whether or not a MAC address of the host is registered in a management table (S314).

If the MAC address of the host is registered in the management table, the MAC address registered in the management table is removed (S317). Meanwhile, if the MAC address of the host is not registered in the management table, the MAC address of the host is registered into the MAC table (S320).

In case that the MAC address of the host is registered in the MAC table, if inaccessibility occurs due to a failure of the corresponding host (S323), the L2 switch moves the registered MAC address of the host to the management table. In other words, while the L2 switch deletes the registered MAC address of the host from the MAC table (S326), the L2 switch registers the deleted MAC address into the management table (S329). Here, as described above, the host failure reflects all error situations of the corresponding host, including the crash of the corresponding host.

If the failed host is restored and again becomes accessible (S332), the process proceeds to the step S311 of requesting the registration to the L2 switch. Then, while the MAC address registered in the management table is deleted, the deleted MAC address is registered into the MAC table. By registering the MAC address into the management table when the failure occurs in the host, all packets received through the L2 switch and to be transmitted to the host can be discarded without broadcasting them, thereby preventing traffic from occurring in the network.

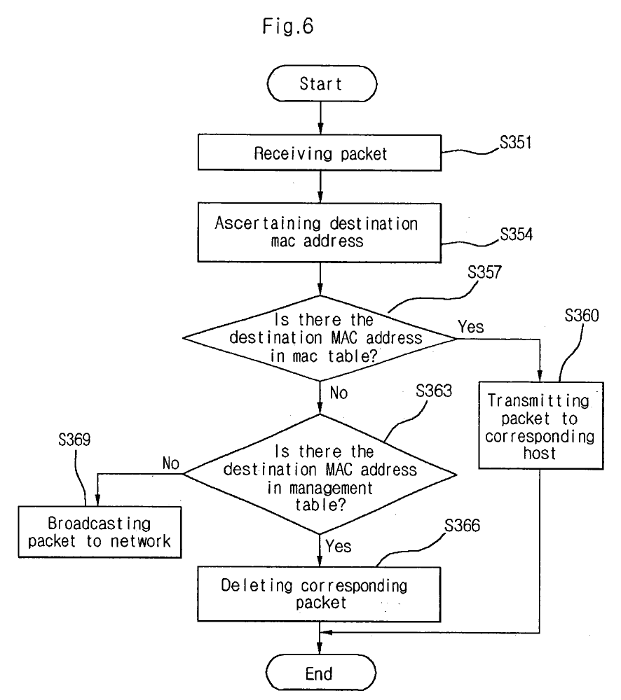

Hereinafter, there will be described a method for transmitting packets inputted into the L2 switch when the host is managed by the L2 switch. FIG. 6 is a packet transmission method in the L2 switch in accordance with a preferred embodiment of the present invention. Referring to FIG. 6, if the L2 switch receives a packet (S351), the L2 switch ascertains a destination MAC address contained in the packet (S354).

The L2 switch retrieves the MAC table to ascertain whether or not the ascertained destination MAC address is in the MAC table (S357). If the MAC address is in the MAC table, the packet is transmitted to a host corresponding to the destination MAC address (S360).

At this time, if inaccessibility occurs due to a failure in the host corresponding to the destination MAC address, the L2 switch deletes the MAC address of the host from the MAC table and registers the deleted MAC address into the management table, as described in FIG. 5. Consequently, in case that a failure occurs in the host corresponding to the destination MAC address, the MAC address of the host exists in the management table. Accordingly, the L2 switch ascertains whether or not the destination MAC address of the packet is in the management table (S363).

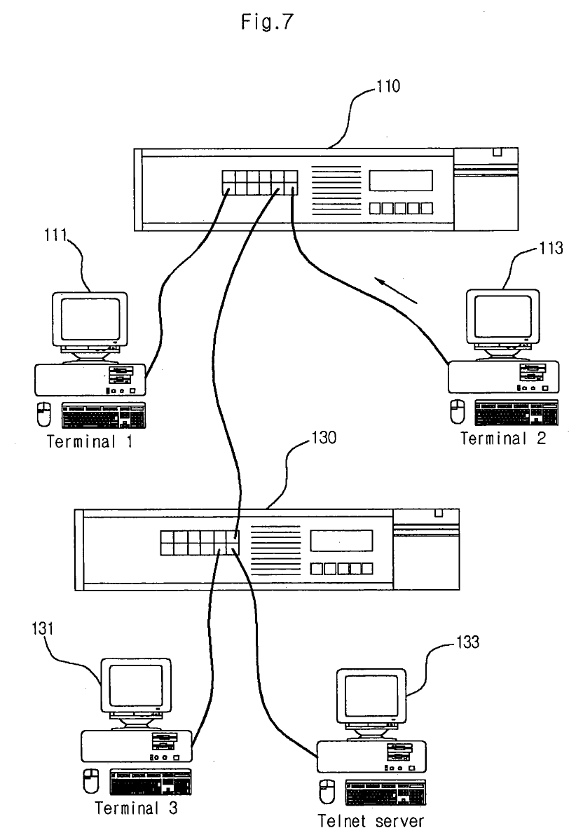

If the destination MAC address of the packet is in the management table, the L2 switch discards the packet instead of transmitting the packet to the network (S366). Only if the destination MAC address of the packet is in the management table due to the host failure, all packets inputted into the L2 switch to be transmitted to the host through a plurality of terminals are discarded. Therefore, as shown in FIG. 7, in case that a failure occurs in the TELNET server 133, if a packet to be transmitted to the TELNET server 133 is inputted into the L2 switch 110 from the terminal 113, the packet is discarded in the L2 switch 110, so that the packet is not broadcast to the terminal 111, the terminal 131 and various servers.

Meanwhile, if the destination MAC address of the packet is also not in the MAC table, the packet is broadcast to the network (S369). In case that a failure occurs in the host, the destination MAC address must exist in the management table. Nevertheless, no existence of the destination MAC address in the management table means that an error occurs in the L2 switch. In that case, the packet is broadcast to the network. Of course, even when the destination MAC address of the packet is not in the management table, the L2 switch can be designed to discard the packet.

As described above, according to the packet transmission method in the network switch of an embodiment of the present invention, the additional management table different from the MAC table is provided. If a failure occurs in the host, the MAC address of the host is registered into the management table and the received packet is discarded, thereby preventing traffic from occurring in the network and improving packet transmission efficiency. According to the host management method in the network switch of an embodiment of the present invention, if a failure occurs in the host, the previously registered MAC address of the host is moved to the management table, so that the packet can be efficiently transmitted.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A packet transmission method in a network switch, comprising:
receiving a packet;
determining if a destination MAC address of the packet is in a MAC table;
determining if the destination MAC address of the packet is in a management table if the destination MAC address of the packet is not in the MAC table; and
discarding the packet if the destination MAC address of the packet is in the management table.

2. The packet transmission method according to claim 1, further comprising transmitting the packet to a host corresponding to the destination MAC address of the packet if the destination MAC address of the packet is in the MAC table.

3. The packet transmission method according to claim 1, further comprising broadcasting the packet to a network if the destination MAC address of the packet is not in the management table or the MAC table.

4. A host management method in a network switch, comprising:
receiving a registration request for registering a host in a MAC table;
registering a MAC address of the host into the MAC table;
determining if the host becomes inaccessible; and
transferring the MAC address of the host registered in the MAC table to a management table if the host becomes inaccessible.

5. The host management method according to claim 4, wherein the host is inaccessible if the host fails.

6. The host management method according to claim 4, wherein transferring the registered MAC address of an inaccessible host to the management table comprises:
removing the registered MAC address from the MAC table; and
registering the removed MAC address in the management table.

7. The host management method according to claim 4, further comprising transferring the MAC address registered in the management table to the MAC table if the host becomes accessible.

8. The host management method according to claim 7, wherein transferring the registered MAC address of an accessible host to the MAC table comprises:
removing the registered MAC address from the management table; and
registering the removed MAC address in the MAC table.

9. The host management method according to claim 4, further comprising monitoring a status of the host.

10. The host management method according to claim 9, further comprising transferring the MAC address of the host registered in the MAC table to the management table if the status of the host indicates the host is inaccessible.

11. The host management method according to claim 10, further comprising transferring the MAC address of the host registered in the management table to the MAC table if the status of the host indicates the host is accessible.

12. A packet transmission method for transmitting a packet from a network switch to a host comprising:
inputting a packet in the network switch, the packet adapted to be transmitted to a host;
discarding the packet if a MAC address of the host is registered in a management table because of inaccessibility of the host.

13. A network management method, comprising:
receiving a registration request from a remote device;
determining if the remote device is registered in a first table;
adding an address for the remote device to the first table if the remote device is not in the first table;
monitoring a status of the remote device;
receiving a packet for transmission to the remote device; and
preventing transmission of the packet to the remote device if the status of the remote devices indicates the remote device is inaccessible.

14. Ache method of claim 13, further comprising adding the address for the remote device to a second table if the status indicates the remote device is inaccessible.

15. The method of claim 13, further comprising removing the remote device from the first table if the status indicates the remote device is inaccessible.

16. The method of claim 15, further comprising adding the address for the remote device to a second table if the status indicates the remote device is inaccessible.

17. The method of claim 16, further comprising removing the address for the remote device from the second table and adding the address for the remote device to the first table if the status of the remote device indicates the remote device is accessible.

18. The method of claim 16, further comprising monitoring the status of the remote device continuously.

19. The method of claim 16, further comprising monitoring the status of the remote device when the packet is received.

20. The method of claim 16, further comprising monitoring the status of the remote device when a registration request is received.
